(19) United States
(12) Patent Application Publication
(10) Pub. No.: US 2015/0294259 A1
(43) Pub. Date: Oct. 15, 2015

(54) CONVERSATIONAL TASKING SYSTEM

(71) Applicant: switchedOn, Inc., Lewes, DE (US)

(72) Inventor: Jason L. Collins, Newark, DE (US)

(21) Appl. No.: 14/751,525

(22) Filed: Jun. 26, 2015

(51) Int. Cl. G06Q 10/06

(52) U.S. Cl. CPC G06Q 10/063114

(57) ABSTRACT

A system and method for conversational tasking, including: providing a messaging client that enables a corresponding user of a set of users of a conversational tasking system to create an assigned task by composing a message describing the assigned task using conversational language; extracting the assigned task from the message; and posting the assigned task to an assigned task store that enables the users to access and update a status of the assigned task posted in the assigned task store.

### BACKGROUND

A messaging system can enable a set of individual to communicate with one another using conversational language. For example, an email system can enable a set of users of the email system to compose and send messages to one another using conversational language in email messages.

A messaging system based on conversational language can be used for task-oriented conversations among a team of individuals. In a business context, for example, a messaging system can enable individual members of a business team to assign tasks to one another, to accept assigned tasks, to follow up on assigned tasks, etc., using conversational language.

A tasking system can be used to manage the tasks that originate in messaging conversations among individual members of a business team. A tasking system can have a form-oriented structure in which tasks are entered into the tasking system by filling out forms. It may be up to the individual members of a business team to ensure that the tasks discussed in their messaging conversations are actually being entered into their tasking system and not getting lost in long message threads.

### SUMMARY

In general, in one aspect, the invention relates to a conversational tasking system. The conversational tasking system can include: a messaging client that enables a corresponding user of a set of users of the conversational tasking system to create an assigned task by composing a message describing the assigned task using conversational language; a conversational tasking client that extracts the assigned task from the message; and a tasking platform that enables the conversational tasking client to post the assigned task to an assigned task store such that the tasking platform enables the users to access and update a status of the assigned task posted in the assigned task store.

In general, in another aspect, the invention relates to a method for conversational tasking. The method can include: providing a messaging client that enables a corresponding user of a set of users of a conversational tasking system to create an assigned task by composing a message describing the assigned task using conversational language; extracting the assigned task from the message; and posting the assigned task to an assigned task store that enables the users to access and update a status of the assigned task posted in the assigned task store.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates creating an assigned task in a conversational tasking system in one or more embodiments.

FIGS. 2A-2B are examples of a user of a conversational tasking system creating an assigned task by composing a message using conversational language.

FIGS. 3A-3B show examples of popup lists in an example user interface that assist a user of a conversational tasking system when creating an assigned task by composing a message using conversational language.

FIG. 4 illustrates an example of a message for creating an assigned task using conversational language in one or more embodiments.

FIG. 5 illustrates a user responding to an assigned task in a conversational tasking system in one or more embodiments.

FIG. 6 is an example user interface that enables a user of a conversational tasking system to provide a response to an assigned task.

FIG. 7 shows an example of the contents of an assigned task store in one or more embodiments.

FIG. 8 shows an embodiment of a conversational tasking system based on email messaging via an email platform.

FIG. 9 illustrates an example of an assigned task message board in one or more embodiments.

FIG. 10 illustrates a method for conversational tasking in one or more embodiments.

FIG. 11 illustrates a computing system upon which portions of a conversational tasking system can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

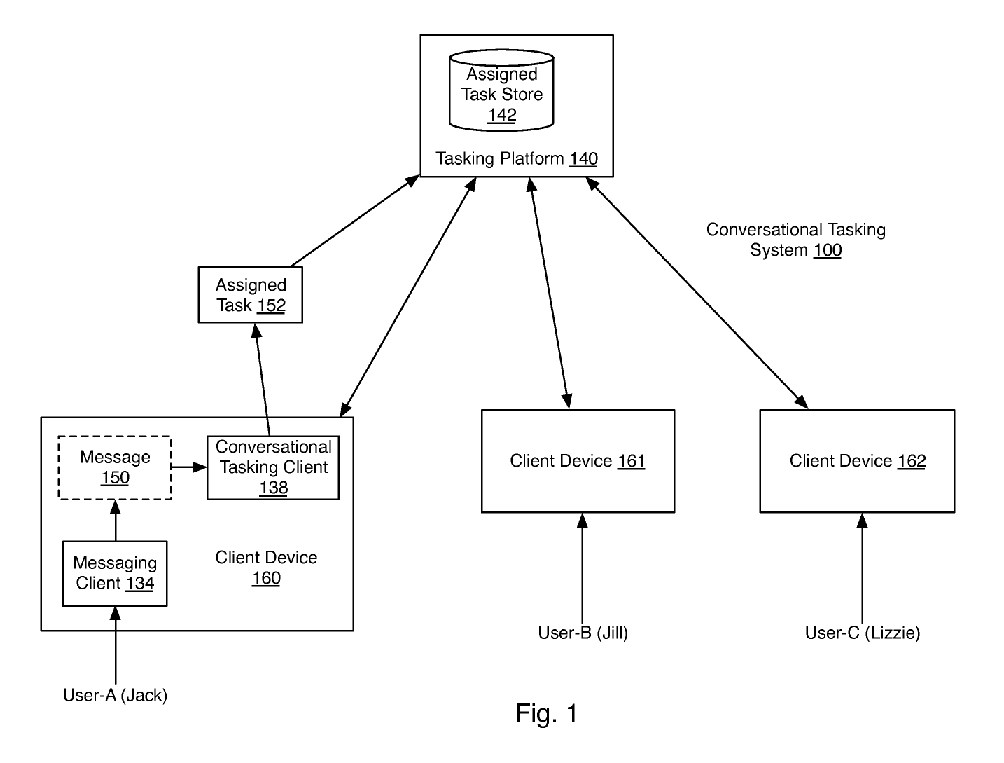

FIG. 1 illustrates creating an assigned task 152 in a conversational tasking system 100 in one or more embodiments. The conversational tasking system 100 in this example is used by a set of registered users—User-A, User-B, and User-C, who are named Jack, Jill, and Lizzie, respectively. Jack, Jill, and Lizzie access the conversational tasking system 100 using their respective client devices 160-162.

The client device 160 includes a messaging client 134 that enables Jack to create an assigned task 152 by composing a message 150 describing the assigned task 152 using conversational language. Jack can compose the message 150 to include a mention of one or more of the users of the conversational tasking system 100. Jack can compose the message 150 to include a set of parameters for the assigned task 152.

The client device 160 includes a conversational tasking client 138 that extracts the assigned task 152 from the message 150. The conversational tasking system 100 includes a tasking platform 140 that enables the conversational tasking client 138 to post the assigned task 152 to an assigned task store 142. The tasking platform 140 enables the users of the conversational tasking system 100, Jack, Jill, and Lizzie, to access and update a status of the assigned task 152 posted in the assigned task store 142.

In one or more embodiments, the conversational tasking client 138 extracts the assigned task 152 from the message 150 by recognizing an ASCII character in the message 150 that is preselected for mentioning the users of the conversational tasking system 100. The ASCII character preselected for mentioning the users can be the “@” character.

In one or more embodiments, the conversational tasking client 138 extracts the assigned task 152 from the message 150 by recognizing one or more ASCII characters in the message 150 that are preselected for specifying parameters for an assigned task. The ASCII characters preselected for specifying parameters can include the “?” character for indicating a deadline parameter and the “!” character for indicating a type of action parameter.

In one or more embodiments, the conversational tasking client 138 extracts the entire text body of the message 150 as the assigned task 152. The conversational tasking client 138 can determine which user of the conversational tasking system 100 is being assigned the assigned task 152 by examining addressing information associated with the message 150.

The messaging client 134 can enable Jack to type, speak, etc., text when creating the message 150. Examples of the client devices 160-162 include any combination of personal computers, laptops, mobile devices, e.g., tablets, smartphones, wearable devices, etc. Examples of the messaging client 134 include an email client of an email platform, an instant messaging client of an instant messaging platform, a social networking client of a social networking platform, etc.

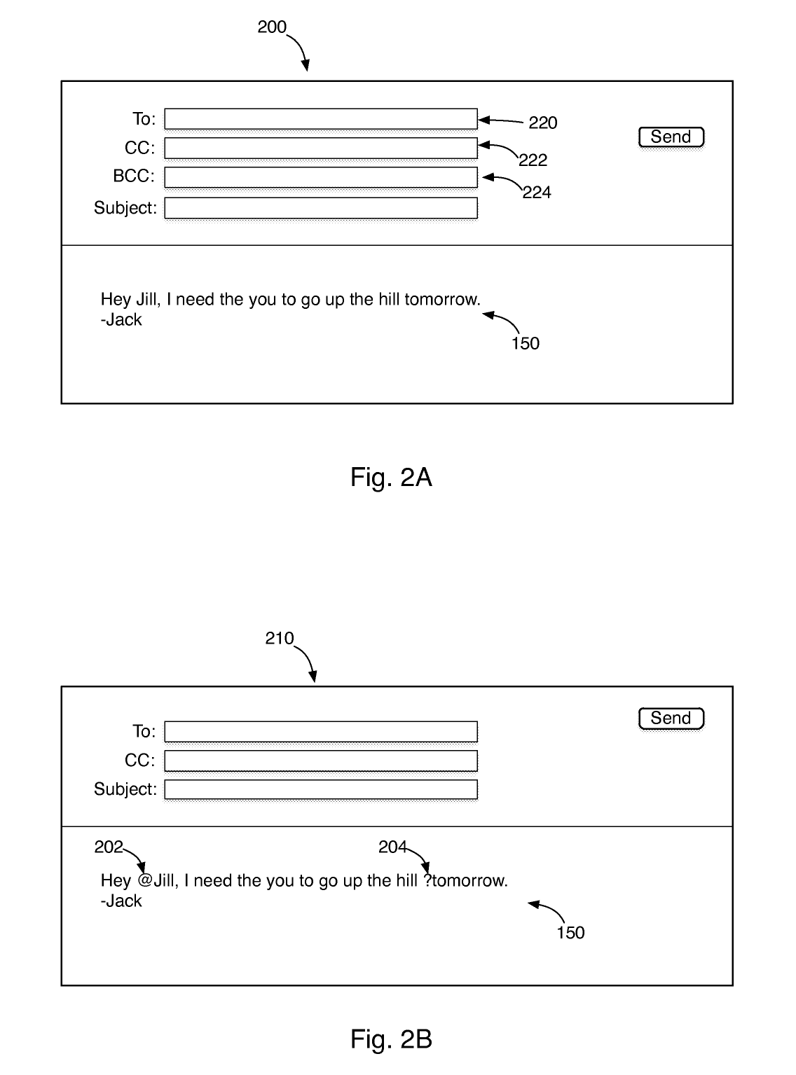

FIG. 2A shows Jack creating the assigned task 152 by composing the message 150 that describes the task 152 using conversational language via a user interface 200 in one or more embodiments. The user interface 200 can be generated by the messaging client 134. In this example, Jack describes the assigned task 152 in the text body of the message 150 and assigns it to Jill by entering Jill's address, handle, etc., in a “To:” field 220 or a “CC:” field 222 or a “BCC:” field 224 of the user interface 200.

FIG. 2B shows another example of Jack creating the assigned task 152 by composing the message 150 using conversational language via the user interface 200 in one or more embodiments. In this example, Jack includes a mention of Jill for the assigned task 152 by entering a preselected ASCII character 202 when composing the message 150 via the user interface 200. Jack also specifies a deadline parameter for the assigned task 152 by entering a preselected ASCII character 204 when composing the message 150 via the interface 200.

The conversational tasking client 138 recognizes a mention of Jill in the message 150 in response to the “@Jill” character string in the message 150. The conversational tasking client 138 recognizes a deadline parameters in the message 150 in response to the “?tomorrow” character string in the message 150.

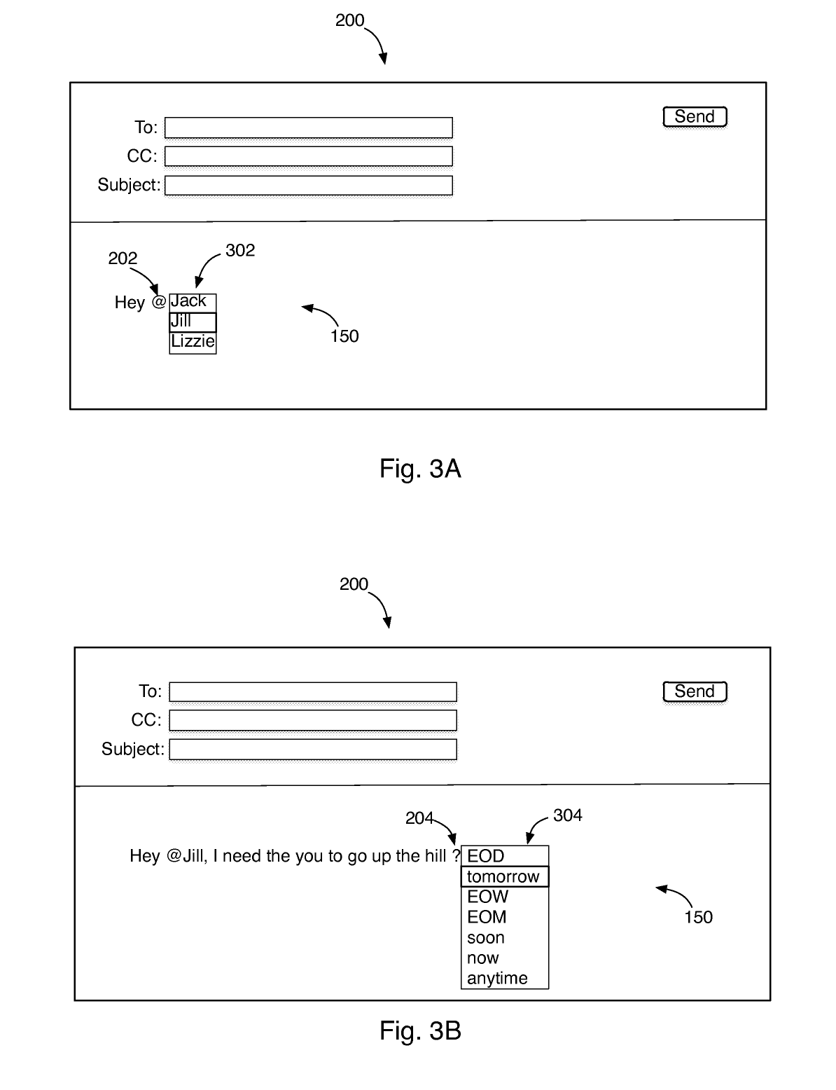

FIG. 3A shows an example of a popup list 302 in the user interface 200 that assists Jack when entering a mention in the message 150. The popup list 302 can appear in response to Jack entering the preselected ASCII character 202 when composing the message 150. The popup list 302 enables Jack to select Jill from a list of the registered users of the conversational tasking system 100. In one or more embodiments, the popup list 302 can include a subset of the registered users of the conversational tasking system 100 who are members of a particular team to which the message 150 and the corresponding email conversation pertains. The popup list 302 can enable Jack to select Jill via, e.g., a mouse click or touchscreen gesture, etc.

In one or more embodiments, the popup list 302 can enable Jack to select users listed in one or more contact repositories belonging to Jack. The contact repositories can be stored on Jack's client device 160 or on a cloud system accessible by Jack via the client device 160.

FIG. 3B shows an example of a popup list 304 in the user interface 200 that assists Jack when entering a parameter for the assigned task 152 in the message 150. The popup list 304 can appear in response to Jack entering the preselected ASCII character 204 when composing the message 150 after Jack has made a mention in the message 150 using the preselected ASCII character “@”. The popup list 304 is not triggered in response to the “?” character before Jack enters the mention in the message 150 via the “@” character. The popup list 304 enables Jack to select from a list of possible deadline parameters for the assigned task 152. The popup list 304 can enable Jack to select a deadline parameter from the list via, e.g., a mouse click or touchscreen gesture, etc.

In one or more embodiments, Jack can enter additional text after entering the preselected ASCII character 204 and the user interface 200 can autocomplete the deadline. For example, if Jack enters “Mo” after “?” then the user interface 200 can autocomplete it to “Monday” or autocomplete it to “tomorrow”. In another example, if Jack enters “to” after “?” then the user interface 200 can autocomplete it to “today” or to “tomorrow” or to “tonight”.

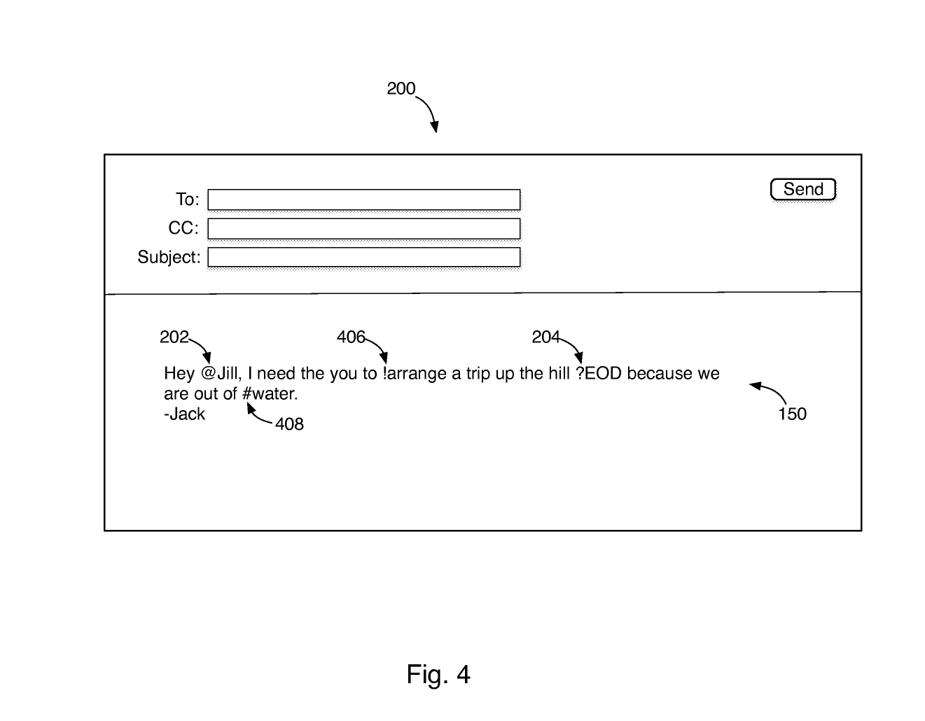

FIG. 4 illustrates another example of the message 150 in one or more embodiments. In this example, Jack specifies a type of action in the message 150 by entering a preselected ASCII character 406 when composing the message 150. The preselected ASCII character 406 can be the “!” character. In this example, the type of action indicated by the character “!” is to “arrange” a trip up the hill which is stated in conversational language in the message 150. The user interface 200 can generate a popup list of preselected actions in response to Jack entering the preselected ASCII character 406 into the message 150 after Jack has made a mention in the message 150 using the preselected ASCII character “@”. A popup list is not triggered in response to the “!” before Jack enters the mention in the message 150. The user interface 200 can autocomplete entries made by Jack following the preselected ASCII character 406.

Jack specifies a tag for the assigned task 152 in this example by entering the preselected ASCII character 408 when composing the message 150. The preselected ASCII character 408 can be the “#” character. In this example, the tag indicated by the character “#” is “water” which is used in conversational language in the message 150. The user interface 200 can generate a popup list of tags in response to Jack typing out a tag in the message 150 after the “#” character. The popup list of tags can be based on a history of tags used by Jack or used by a team to which Jack belongs. The user interface 200 can autocomplete tag entries made by Jack following the preselected ASCII character 408.

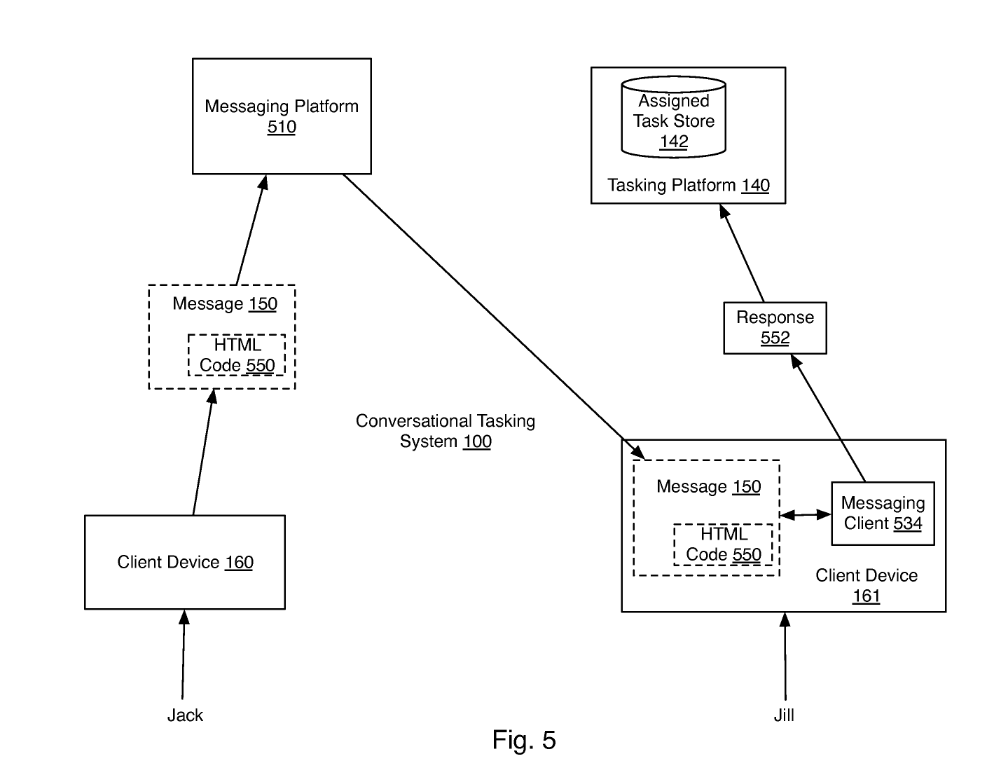

FIG. 5 illustrates a mechanism that enables Jill to respond to the assigned task 152 in one or more embodiments of the conversational tasking system 100. Jill's client device 161 includes a messaging client 534 that enables her to read the message 150 authored by Jack. The message 150 can be routed from the client device 160 of Jack to the client device 161 of Jill via a messaging platform 510. For example, the messaging platform 510 can be an email platform and the messaging clients 134 and 534 can be email clients of the email platform. In another example, the messaging platform 510 can be an instant messaging platform and the messaging clients 134 and 534 can be instant messaging clients of the instant messaging platform. In yet another example, the messaging platform 510 can be a social network platform and the messaging clients 134 and 534 can be clients of the social network platform.

The conversational tasking client 138 (FIG. 1) on Jack's client device 160 in one or more embodiments embeds a set of HTML code 550 in the message 150 before it is sent to Jill via the messaging platform 510. The HTML code 550 includes a hyperlink that maps to the tasking platform 140. The messaging client 534 on Jill's client device 161 generates a user interface to Jill in response to the message 150 with the embedded HTML code 550 such that the user interface enables Jill to post a response 552 to the assigned task 152 carried in the message 150 to the assigned task store 142.

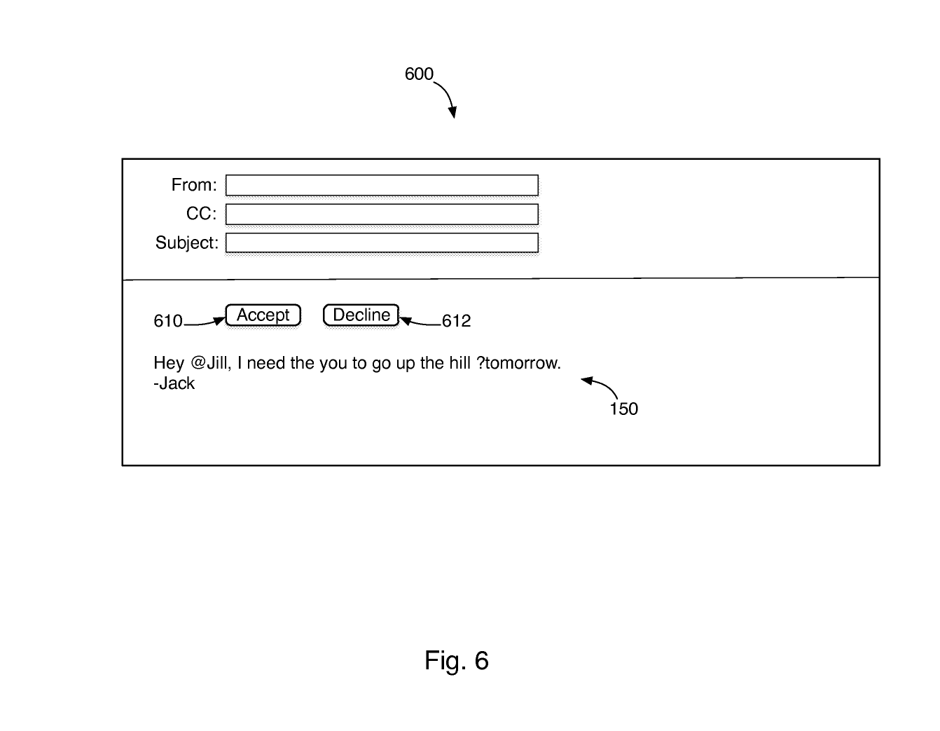

FIG. 6 shows an example user interface 600 on the client device 161 that enables Jill to post the response 552 to the assigned task 152. The user interface 600 displays the message 150 to Jill and, in this example embodiment, the HTML code 550 includes a button 610 that enables the Jill to accept the assigned task 152 carried in the message 150 and a button 612 that enables Jill to decline the assigned task 152 carried in the message 150. Jill's accept or decline selection is posted to the tasking platform 140 via the response 552, e.g., an HTTP hyperlink POST command.

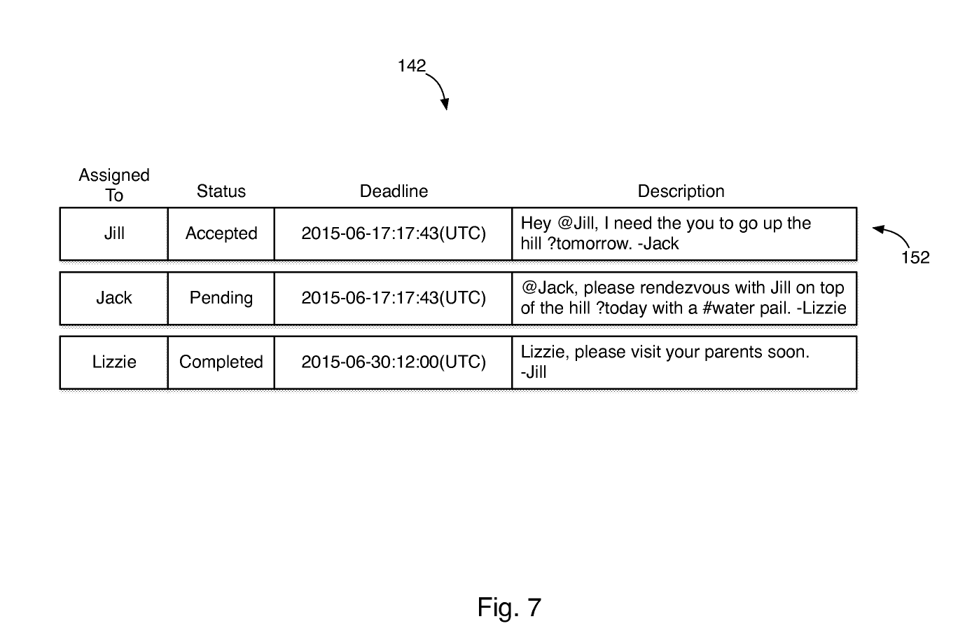

FIG. 7 shows an example of the contents of the assigned task store 142 in one or more embodiments. The assigned task store 142 in this example holds three assigned tasks including the assigned task 152 derived from the message 150 composed by Jack. The status for the assigned task 152 posted in the assigned task store 142 indicates that Jill has accepted the assigned task 152 via the user interface 600.

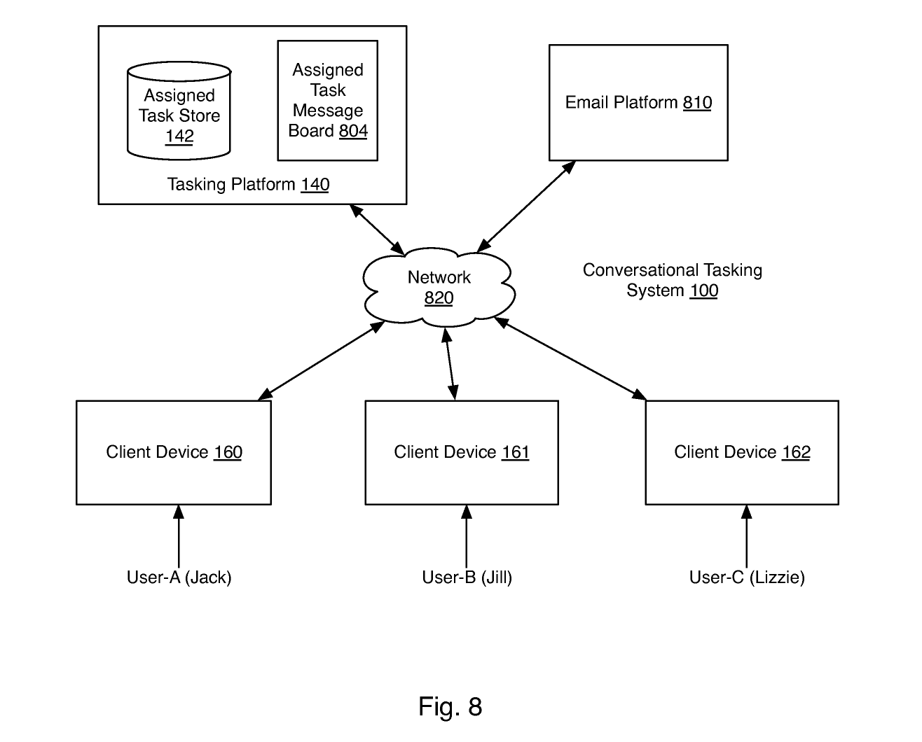

FIG. 8 shows an embodiment of the conversational tasking system 100 based on email messaging via an email platform 810. The client devices 160-162 include respective email clients of the email platform 810 that enable Jack, Jill, and Lizzie to compose email messages and send them to one another via a network 820 and via the email platform 810 on the network 820. The client devices 160-162 enable Jack, Jill, and Lizzie to create assigned tasks using conversational language in their email messages to one another and to respond to assigned tasks and to post their assigned tasks and responses to assigned tasks to the assigned task store 142 in the tasking platform 140 via the network 820. In one or more embodiments, the client devices 160-162 communicate with the tasking platform 140 using web protocols via the network 820.

The conversational tasking system 100 in one or more embodiments includes an assigned task message board 804 that enables Jack, Jill, and Lizzie to synchronize their communications regarding their assigned tasks posted in the assigned task store 142.

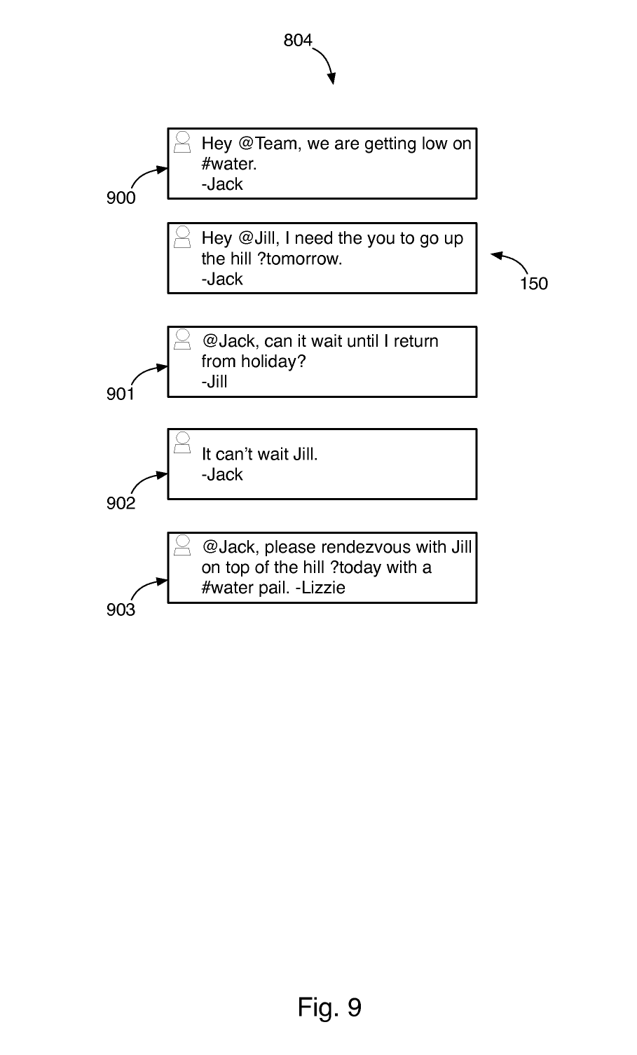

FIG. 9 illustrates an example of the assigned task message board 804 of the tasking platform 140 in one or more embodiments. The assigned task message board 804 includes the message 150 originally authored by the Jack via the messaging client 134 when creating the assigned task 152. The message board 104 includes a series of messages 900-903 that pertain to the same message conversation as the message 150. Any of the messages 900-903 may have been originally created by a messaging client in a client device of the conversational tasking system 100 or may have been originally created using a message creation function on the tasking platform 140. The tasking platform 140 synchronizes the message 150 with the messages 900-903 using, e.g., time stamps associated with the message 150 and the messages 900-903, meta-data associated with the message 150 with the messages 900-903, etc.

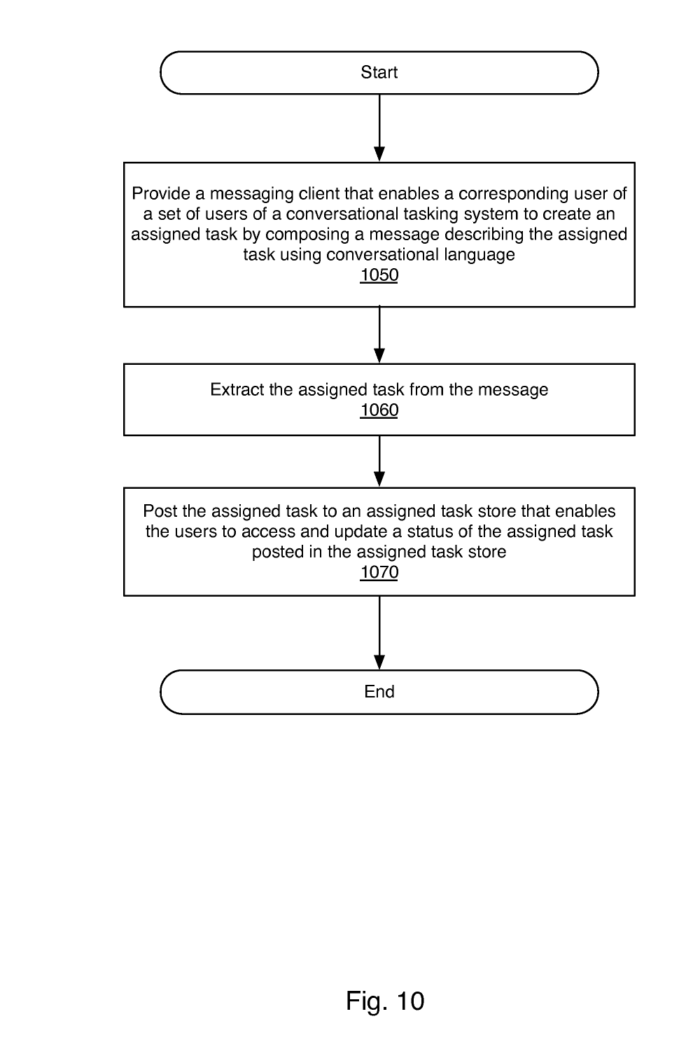

FIG. 10 illustrates a method for conversational tasking in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 10 should not be construed as limiting the scope of the invention.

At step 1050, a messaging client is provided that enables a corresponding user of a set of users of a conversational tasking system to create an assigned task by composing a message describing the assigned task using conversational language. The messaging client can be an email client, an instant messaging client, a social networking client, or any messaging client that enables a user to compose a message using conversational language. The message can include a mention of one or more users of the conversational tasking system, a deadline for the assigned task, an action to be performed for the assigned task, or a tag to be associated with the assigned task.

At step 1060, the assigned task is extracted from the message. The assigned task can be extracted from the entire text body of the message or in response to preselected characters in the message that indicate mentions, parameters, or tags associated with the assigned task. At step 1070, the assigned task is posted to an assigned task store that enables the users to access and update a status of the posted assigned task.

Embodiments of the invention may be implemented on a specialized computer system. Examples of such a computing system can include one or more mobile computing devices (e.g., laptop computer, smart phone, personal digital assistant, tablet computer, or other mobile computing device, game console), desktop computers, servers, blades in a server chassis, or any other type of computing device(s) that include at least the minimum processing power, memory, and input and output device(s) to perform one or more embodiments of the invention. Embodiments of the invention, e.g., the tasking platform 140 may be implemented within a cloud infrastructure.

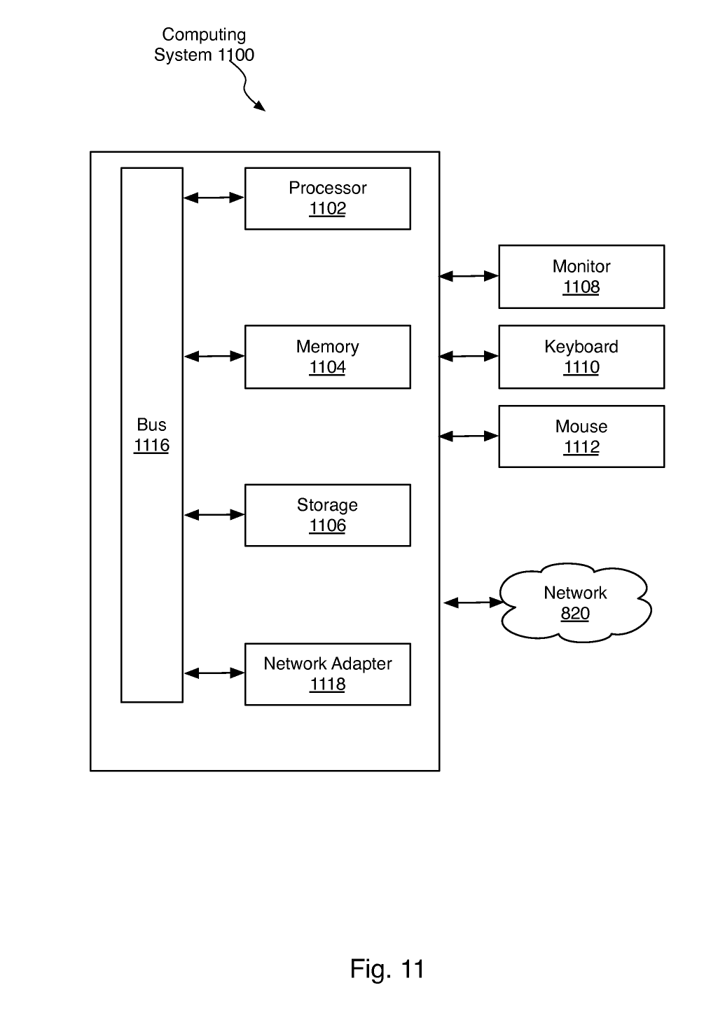

FIG. 11 illustrates a computing system 1100 upon which portions of the conversational tasking system 100 can be implemented. For example, the tasking platform 140, the client devices 160-162, as well as other elements of the conversational tasking system 100 can be implemented on the computing system 1100. The computing system 1100 includes one or more computer processor(s) 1102, associated memory 1104 (e.g., random access memory (RAM), cache memory, flash memory, etc.), one or more storage device(s) 1106 (e.g., a hard disk, an optical drive such as a compact disk (CD) drive or digital versatile disk (DVD) drive, a flash memory stick, etc.), a bus 1116, and numerous other elements and functionalities. The computer processor(s) 1102 may be an integrated circuit for processing instructions. For example, the computer processor(s) may be one or more cores or micro-cores of a processor. The computing system 1100 may also include one or more input device(s), e.g., a touchscreen, keyboard 1110, mouse 1112, microphone, touchpad, electronic pen, or any other type of input device. Further, the computing system 1100 may include one or more monitor device(s) 1108, such as a screen (e.g., a liquid crystal display (LCD), a plasma display, touchscreen, cathode ray tube (CRT) monitor, projector, or other display device), external storage, input for an electric instrument, or any other output device. The computing system 1100 may be connected to the network 820 (e.g., a local area network (LAN), a wide area network (WAN) such as the Internet, mobile network, or any other type of network) via a network adapter 1118.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A conversational tasking system, comprising:
a messaging client that enables a corresponding user of a set of users of the conversational tasking system to create an assigned task by composing a message describing the assigned task using conversational language;
a conversational tasking client that extracts the assigned task from the message; and
a tasking platform that enables the conversational tasking client to post the assigned task to an assigned task store such that the tasking platform enables the users to access and update a status of the assigned task posted in the assigned task store.

2. The conversational tasking system of claim 1, wherein the conversational tasking client extracts the assigned task from the message by recognizing an ASCII character in the message that is preselected for indicating a mention of at least one of users.

3. The conversational tasking system of claim 2, wherein the messaging client generates a popup list of the users in response to an entry of the preselected ASCII character into the message by the user of the messaging client such that the popup list enables the user of the messaging client to enter the mention in the message by selecting from the popup list.

4. The conversational tasking system of claim 1, wherein the conversational tasking client extracts the assigned task from the message by recognizing an ASCII character in the message that is preselected for indicating a parameter for the assigned task.

5. The conversational tasking system of claim 4, wherein the messaging client generates a popup list of a set of possible parameters in response to an entry of the preselected ASCII character into the message by the user of the messaging client such that the popup list enables the user of the messaging client to enter the parameter into the message by selecting from the popup list.

6. The conversational tasking system of claim 4, wherein the parameter is a deadline for the assigned task.

7. The conversational tasking system of claim 4, wherein the parameter is an action to be performed for the assigned task.

8. The conversational tasking system of claim 1, wherein the messaging client embeds a set of HTML code in the message such that when the message is presented to at least one of the users who receive the message enables the user who receives the message to post a response to the assigned task to the tasking platform.

9. The conversational tasking system of claim 1, wherein the tasking platform includes an assigned task message board that synchronizes the message to a set of other messages pertaining to the assigned task.

10. The conversational tasking system of claim 1, wherein the conversational tasking client extracts the assigned task from the message by recognizing an ASCII character in the message that is preselected for specifying a tag for the assigned task.

11. A method for conversational tasking, comprising:
providing a messaging client that enables a corresponding user of a set of users of a conversational tasking system to create an assigned task by composing a message describing the assigned task using conversational language;
extracting the assigned task from the message; and
posting the assigned task to an assigned task store that enables the users to access and update a status of the assigned task posted in the assigned task store.

12. The method of claim 11, wherein extracting comprises extracting the assigned task from the message by recognizing an ASCII character in the message that is preselected for indicating a mention of at least one of users.

13. The method of claim 12, further comprising generating a popup list of the users in response to an entry of the preselected ASCII character into the message by the user of the messaging client such that the popup list enables the user of the messaging client to enter the mention in the message by selecting from the popup list.

14. The method of claim 11, wherein extracting comprises extracting the assigned task from the message by recognizing an ASCII character in the message that is preselected for indicating a parameter for the assigned task.

15. The method of claim 14, further comprising generating a popup list of a set of possible parameters in response to an entry of the preselected ASCII character into the message by the user of the messaging client such that the popup list enables the user of the messaging client to enter the parameter into the message by selecting from the popup list.

16. The method of claim 14, wherein the parameter is a deadline for the assigned task.

17. The method of claim 14, wherein the parameter is an action to be performed for the assigned task.

18. The method of claim 11, further comprising embedding a set of HTML code in the message such that when the message is presented to at least one of the users who receive the message enables the user who receives the message to post a response to the assigned task to the tasking platform.

19. The method of claim 11, further comprising synchronizing the message to a set of other messages pertaining to the assigned task.

20. The method of claim 11, wherein extracting comprises extracting the assigned task from the message by recognizing an ASCII character in the message that is preselected for specifying a tag for the assigned task.
